(19) United States
(12) Patent Application Publication
(10) Pub. No.: US 2018/0255750 A1
(43) Pub. Date: Sep. 13, 2018

(54) DEVICE AND METHOD FOR CLEANING AQUARIUMS

(71) Applicant: Kristopher L. Anderson, Dublin, OH (US)

(72) Inventor: Kristopher L. Anderson, Dublin, OH (US)

(21) Appl. No.: 15/864,904

(22) Filed: Jan. 8, 2018

Related U.S. Application Data
(60) Provisional application No. 62/443,077, filed on Jan. 6, 2017.

(51) Int. Cl. A01K 63/10; A01K 63/04; A01K 63/00

(52) U.S. Cl. CPC A01K 63/10; A01K 63/006; A01K 63/047

(57) ABSTRACT

Aquarium cleaning device and method, wherein the device may comprise a body adapted to be held for the cleaning of an aquarium. The body is configured to receive a barrel member at an end of the body, which defines an opening into the body. The barrel member may be inserted into an aquarium and has a hollow center which permits receipt of water or debris from the aquarium. The barrel member may be adapted to receive a variety of cleaning accessories. The cleaning accessories may be of various shapes such that they permit for the same device to be able to access and clean in and around different areas of the aquarium. In addition, at least portion of the barrel and/or an accessory may be flexible to facilitate cleaning of difficult to reach areas of aquarium.

### PRIORITY

This application claims priority to U.S. Provisional Application No. 62/443,077, which was filed on Jan. 6, 2017, the entirety of which is incorporated herein by reference.

### TECHNICAL FIELD

Exemplary embodiments relate to devices and methods for cleaning aquariums.

### BACKGROUND AND SUMMARY OF THE INVENTION

The quality of the water within an aquarium determines the continued health and growth of its inhabitants. Aquarium water quality is not merely an aesthetic concern but is a key aspect of managing the health of its fish. As chemicals are added to and removed from the water of an aquarium, the water quality is affected. Because aquariums are closed systems in which concentrations of chemicals, nutrients, etc. are added over time, the chemicals may eventually exceed or fall below a desirable level in the aquarium. When an aquarium system is unbalanced, many undesirable aquarium conditions begin to manifest due to poor water quality. Because the water within an aquarium contains bacteria that is critical for the health of fish as well as harmful bacteria, cleaning an aquarium properly will sometimes include changing all of the water within a tank to remove nitrogenous pollutants and waste, but will often times include removing smaller portions of water from particular areas of the tank and/or removing algae and/or other types of undesired materials from aquarium surfaces including but not limited to the walls of the aquarium, gravel, aquarium decor, aquarium life such as coral, etc.

There are known devices and methods for changing the water and/or cleaning surfaces and items within an aquarium. However, the known devices leave much to be desired. For example, many of the known aquarium cleaning devices comprise a member of a fixed shape that can be manually placed into an aquarium. The member defines an opening/cavity that is connected to a tube, whereby the device is used to draw water and debris into the opening/cavity and through the tube and then out of aquarium. The fixed shape member of these devices is often bulky, and it often cannot access desired surfaces and/or get around certain items (such as decor or coral) within the tank. Therefore, there is a need in the art for an aquarium cleaning device that has a form that is able to be selectively manipulated or otherwise altered in order to accommodate, access, and clean areas within the aquarium that might otherwise be difficult to access, as well as still clean more accessible areas within the aquarium. There is also a need for a device that can selectively receive one or more cleaning attachments such that changing the attachment of the device provides accessibility to surfaces and areas within the aquarium that would otherwise be out of reach and/or provides unique cleaning functionality to the device. Furthermore, there is a need for improved bodies/handles, pump systems, power systems, or other attachments to facilitate access to certain areas of the tank or otherwise facilitate cleaning of the aquarium.

Exemplary embodiments of the present invention address one or more shortcomings of the known art. For example, some exemplary embodiments of an aquarium cleaning device and method may comprise a body adapted to be held by a human hand for the cleaning of an aquarium wherein the body is configured to receive and selectively maintain a barrel member at an end point of the body which defines an opening into the body. The barrel member preferably is adapted to be inserted into an aquarium and has a hollow center which permits for the receipt of water and/or debris from the aquarium. The barrel member may have a first end which is adapted to be received and selectively maintained by the body and a second end which may be adapted to receive and selectively maintain a variety of cleaning accessories. The cleaning accessories may be of various shapes such that they permit for the same device to be able to access and clean in and around different areas of the aquarium. The cleaning accessory connected to the second end of the barrel may be selected from the following group in some embodiments: a curved nozzle, a curved brush tip, a scraper, a tip defining multiple openings for water jets, a pipe cleaner, and a flexible pipe hose. The barrel is preferably transparent so that a user of the device can easily see what has been removed from the aquarium during cleaning. In some embodiments, an aquarium cleaning device comprises one or more barrels that may be affixed interchangeably to more than one body and wherein each of said one or more barrels may selectively receive and maintain one or more of a variety of cleaning attachments at the end which is not connected to the body. The various cleaning attachments/accessories preferably provide different shapes and functions for aquarium cleaning.

The body preferably maintains a motor at its interior wherein the motor runs a pump and is in electrical connectivity with a power source such that activation of the power source, and thus activation of the motor and pump, causes water and/or debris to be drawn from an aquarium and into the barrel when at least the second end of the barrel has been inserted into the aquarium. The power source may be one or more batteries which are selectively maintained in the interior of the body, but in some embodiments, may comprise a cord which is adapted to run electric energy to the motor from a source external to the body such as a power outlet. In some exemplary embodiments, the body may be connected to and/or comprise a pump, which is adapted to be manually operated (i.e. operated by manual application of physical force to the pump) and which does not require an electric power source for water and/or debris to be removed from an aquarium. Some exemplary embodiments of an aquarium cleaning device and method may comprise a body that has a manually operated pump as well as an electric-driven motor so that dual methods of operating the cleaning device/performing the method are available

Some exemplary embodiments of an aquarium cleaning device may comprise a pliable first member having a form/shape that may be selectively manipulated by application of force, thereby enabling the member to be inserted into areas of an aquarium that might otherwise be difficult to reach. The first member may define a cavity at its interior that is connected directly or indirectly with a pump, whereby water and debris may be pulled from the aquarium via the cavity when the pump is activated and/or water or air may be expelled into the aquarium such as to dislodge debris from any surface within the aquarium.

One exemplary embodiment of an aquarium cleaning device of the present invention comprises a pliable first member that is adapted for insertion into a volume of water or other fluid (e.g., an aquarium), wherein the first member has a shape/form that may be selectively manipulated or otherwise altered (e.g., by the application of manual force by a user). In an exemplary embodiment, the shape of the first member may be manually manipulated into a first desired form by a user either before or after the member is inserted into an aquarium. In one exemplary embodiment, the first member is able to substantially maintain its shape in the first form until a user manually applies a force that is of sufficient magnitude to cause the shape of the first member to be altered into a second desired form. In an exemplary embodiment, the first member has flexibility of such a nature that it may be placed into numerous shapes/forms by a user but also has sufficient rigidity such that it is able to substantially maintain selected forms. An exemplary first member may define a cavity at its interior and be connected directly or indirectly to a pump. In a first mode, activating an exemplary pump while the first member is inserted into a volume of water may cause water or air to be expelled from the cavity and into the aquarium such that the flow of water/air may be utilized to clean aquarium surfaces. In another mode, an exemplary embodiment of a pump may draw water and/or debris into the cavity of the member such that it may then be removed from the aquarium. Embodiments of a device may implement one or both of these modes of operation. The pump may be manually powered/operated in some exemplary embodiments, while in other embodiments the pump may have electrical, mechanical, or any other suitable source of power.

In exemplary embodiments comprising a pump and a pliable first member, a balance may be struck between the strength of the pump and the rigidity of the first member such that the force applied to the first member when the pump is activated is not sufficiently strong to cause the form of the first member to be undesirably altered. However, in an exemplary embodiment, the pump may be strong enough to be able to cause a volume of water to be dispensed from the cavity of the first member into the aquarium with enough force to separate unwanted debris from aquarium surfaces and/or to cause water and/or debris to be drawn into the cavity of be removed from the aquarium.

### BRIEF DESCRIPTION OF THE DRAWINGS

Novel features and advantages of the present invention, in addition to those mentioned above, will become apparent to those skilled in the art from a reading of the following detailed description in conjunction with the accompanying drawings wherein identical characters refer to identical parts.

FIG. 1 is a section view of a first exemplary body of an aquarium cleaning device illustrating how an exemplary body may maintain a motor and battery power source;

FIG. 2 is a section view of a second exemplary body of an aquarium cleaning device illustrating how an exemplary body may maintain a motor and battery power source;

FIG. 3 is a side view of the first exemplary aquarium cleaning device wherein a body is shown connected to a transparent barrel which is selectively connected to a curved tip accessory;

FIG. 4 is a side view of the first exemplary aquarium cleaning device shown connected to an opaque barrel which is selectively connected to a curved tip accessory;

FIG. 5 shows a left-side section view of the FIG. 3 embodiment showing an exemplary motor in connectivity with an exemplary battery power source;

FIG. 6 shows a side view of the exemplary body shown in FIGS. 1 and 3;

FIG. 7 shows a left-side section, perspective view of the exemplary body shown in FIGS. 1, 3, and 6 illustrating how the body of the device may comprise a water inlet through which water may be pulled by operation of the motor such that it is drawn into the body and then expressed through the end portion of the body adapted to receive a barrel;

FIG. 8 shows a right-side section, perspective view of the exemplary body shown in FIG. 7;

FIG. 9 shows another left-side section, perspective, partial view of the exemplary aquarium cleaning device shown in FIG. 5;

FIG. 10 shows the exemplary body of FIG. 7 wherein a line and arrows are utilized to show an example of how water may be drawn through the water inlet into the body and out through the end portion of the body adapted to receive a barrel so that the water flow may be utilized for cleaning the aquarium;

FIG. 11 shows a top perspective view of the FIG. 10 embodiment again using a line and arrows to show an example of how water may be drawn into the water inlet and into and back out of the body for aquarium cleaning;

FIG. 12(a) shows a right-side view of an exemplary embodiment of an aquarium cleaning device comprising a bulb body selectively connected to a transparent barrel that is shown selectively connected to an interchangeable nozzle accessory;

FIG. 12(b) shows a variety of accessories that may be selectively connected to an end of the barrel and/or to the body at the opening of the body that is adapted to receive the barrel;

FIG. 13(a) shows a right-side view of an exemplary aquarium cleaning device comprising a body connected to a hand pump lever, which is connected to a pump within the body;

FIG. 13(b) shows a variety of accessories that may be selectively connected to an end of the barrel and/or to the body at the opening of the body that is adapted to receive the barrel;

FIG. 14(a) shows a right-side view of an exemplary aquarium cleaning device comprising a body connected to an ergonomic pump-lever and a pressure control valve, wherein the body is shown selectively connected to a transparent barrel that is shown selectively connected to an interchangeable curved nozzle;

FIG. 14(b) shows a variety of accessories that may be selectively connected to an end of the barrel and/or to the body at the opening of the body that is adapted to receive the barrel;

FIG. 15(a) shows a right-side view an exemplary aquarium cleaning device that comprises an exemplary body that may be similar to FIG. 1, wherein the body further comprises an on-off and speed switch, and wherein the body is shown selectively attached to a transparent barrel that is shown selectively maintaining an interchangeable curved nozzle;

FIG. 15(b) shows the body of FIG. 15(a), wherein the body is shown connected to a pliable pipe-hose at a point of the body adapted to receive a barrel;

FIG. 15(c) shows a variety of accessories that may be selectively connected to an end of the barrel and/or to the body at the opening of the body that is adapted to receive the barrel;

FIG. 16(a) shows a front perspective view of an exemplary aquarium and exemplary aquarium cleaning device, wherein the aquarium cleaning device comprises a body having an interior for maintaining a motor that is connected to and activated by an electric power source, and wherein the body is shown connected to a water intake hose adapted to be placed into an aquarium or other body of water;

FIG. 16(b) is a right-side view of the FIG. 16(a) embodiment, further showing an example of how the body may also be connected to an extendable flex hose that is adapted to selectively receive a barrel (e.g., transparent) adapted to be placed into an aquarium for cleaning, wherein the barrel is shown selectively maintaining an interchangeable curved nozzle accessory;

FIG. 16(c) shows a variety of accessories that may be selectively connected to an end of the barrel and/or to the body at the opening of the body that is adapted to receive the flexible pipe hose;

FIG. 17(a) shows an exemplary aquarium and the exemplary aquarium cleaning device of FIG. 16(a), wherein the water intake hose is shown placed in a bucket and the device is set to a syphon mode, showing an example of how a bucket may be used to receive soiled water from the aquarium via the water intake hose (when the hose is being alternatively utilized as a water outlet);

FIG. 17(b) shows a right-side perspective view of the FIG. 17(a) embodiment; and

FIG. 17 (c) shows a variety of accessories that may be selectively connected to an end of the barrel and/or to the body at the opening of the body that is adapted to receive the flexible pipe hose.

### DETAILED DESCRIPTION OF EXEMPLARY EMBODIMENT(S)

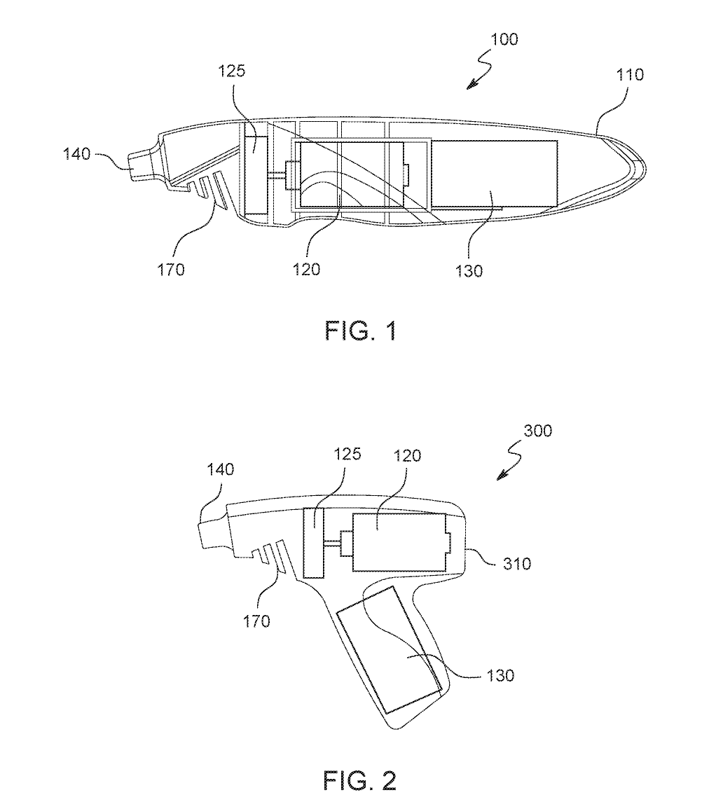

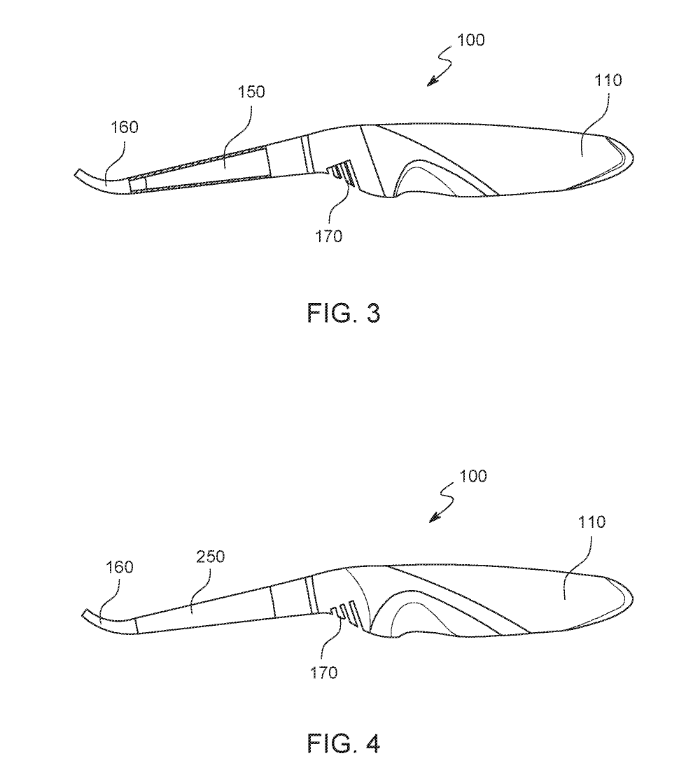

As shown in FIG. 1, a first exemplary embodiment of an aquarium cleaning device 100 of the present invention comprises a body 110 that is adapted to be held by a human hand for the cleaning of an aquarium and which is further adapted to receive a motor 120 connected to a pump 125 at its interior. As shown, the motor 120 may be in connectivity with a battery power source 130 that is selectively maintained in the interior of the body 110. As is further discussed below, some exemplary embodiments of an aquarium cleaning device may utilize a different power source and/or a manual pump instead of a motor. As shown in FIG. 1, the body 110 of the aquarium cleaning device 100, may define an opening 140 at an endpoint of the body 110 that is adapted to selectively receive and maintain a barrel 150 (FIG. 3) and/or another attachment. An example of a barrel 150 adapted to be connected to the body 110 of the aquarium cleaning device 100 may preferably be cylindrical and hollow, having a tubular shape that may be curved, wherein the barrel 150 has a first end and a second end, both of which define an opening into the hollow interior of the barrel 150. The first end of the barrel 150 is adapted to be received by and selectively maintained by the body 110. In some embodiments, corresponding threading about the barrel 150 and the body 110 may permit for the barrel's attachment to the body 110 by “screwing” the threading of the barrel 150 into the corresponding threading of the body 110. In other embodiments, the barrel 150 may be permanently connected to and/or integral with the body 110. The second end of the barrel 150 may be adapted to receive one or more interchangeable attachments. FIG. 3 shows the exemplary aquarium cleaning device 100 of FIG. 1 wherein the body 110 is shown selectively connected to a transparent barrel 150 that is adapted to be inserted into an aquarium for cleaning. As shown, the barrel 150 may be connected to an interchangeable accessory such as the curved nozzle 160 that is shown in FIG. 3. The interchangeable accessories that may be connected to the barrel are preferably distinct in shape and offer various features to permit for the device 100 to be used to clean a wide range of shapes and surfaces or provide other cleaning purposes within the aquarium.

While the barrel 150 of the device 100 is preferably transparent such that it permits for a user to see what is being removed from the aquarium while it is being cleaned, an opaque barrel 250 may be used by some exemplary aquarium cleaning devices such as shown in FIG. 4. In some embodiments, a body 110 may be connected to a variety of barrels 150. For example, a body 110 may be selectively connected to a relatively longer barrel 150 (e.g., longer than nine inches in length) or a relatively short barrel 150 (e.g., less than six inches in length) wherein the barrels 150 are interchangeable on the body 110 and permit for different accessibility into various areas of the aquarium for cleaning. In other embodiments, barrel length may be adjustable by assembling pieces or sections to reach the desired length. For example, similar to Loc-Line™ tubing, barrel pieces may connect or lock together to create joints such that the barrel may remain straight or be bent to various angles. In addition to different lengths, barrels 150 may also have different shapes (e.g., such as to enable access to different areas of an aquarium) and/or different functionalities (e.g., facilitate different cleaning purposes).

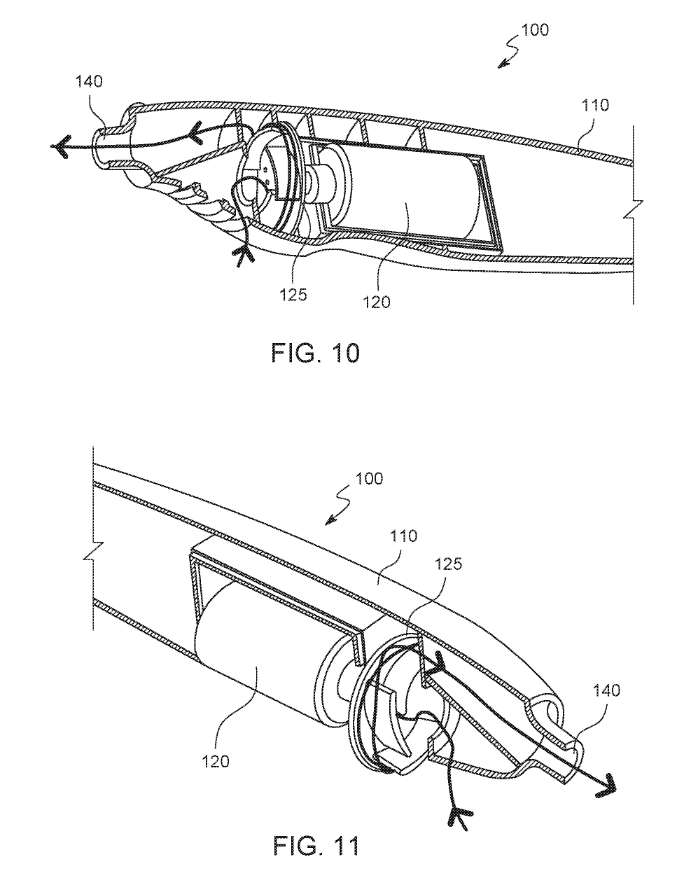

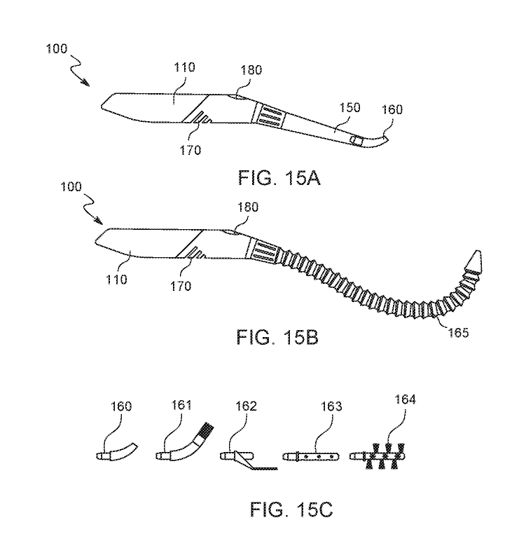

As shown in FIGS. 1 and 3, the aquarium cleaning device 100 may have a body 110 that defines a water inlet 170 that permits for water to be drawn from the aquarium, into the body 110 when the body 110 is at least partially submerged in water and the motor is running. In an exemplary embodiment, when water enters the body 110 through the inlet 170, it may be subsequently pushed out of the body 110 through opening 140 where it can be pushed through the barrel 150 and accessory (if the barrel 150 and an accessory are connected) creating a water flow that can be used to clean the aquarium. In such exemplary embodiments, the pump 125 may rotate in alternate ways such that when it rotates a first way, water is pulled from the aquarium into the barrel 150 so that it may be removed from the aquarium, yet when the pump 125 rotates a second way, water is pulled from the aquarium into the water inlet 170 and then pushed through the body 110 and expelled through opening 140 and (if connected) through the barrel 150 and any corresponding, connected attachment. The lines and arrows shown in FIGS. 10 and 11 illustrate an example of how water may be pulled through the water inlet 170 and pushed through the body 110 and out through the opening 140 so that it may be expelled by the barrel 150 (if connected) and used for cleaning surfaces of the aquarium. In some exemplary embodiments, an aquarium cleaning device comprising a water inlet may have a two-way switch connected to the pump and positioned on the exterior surface of the body 110 (or another accessible location) so that it may control which way water moves through opening 140 and the body 110 for different aquarium cleaning techniques. One example of the two-way switch may be part of, and perhaps an additional feature of, an on-off switch for the pump 125 in some embodiments. FIGS. 15(a) and 15(b) illustrate an exemplary on-off switch 180 of an aquarium cleaning device 100. In some embodiments, an on-off switch 180 may permit for the speed at which water is expelled from and/or drawn into the body 110 of the device 100 to be increased and/or decreased in addition to turning the device on and off. An example of an on-off switch may comprise a dial that permits for a user to set the speed of the water flowing through the device 100 so that it can be changed for various cleaning applications.

In some exemplary embodiments, such as that shown in FIG. 2, an aquarium cleaning device 300 may comprise a body 310 that has a gun-like silhouette, wherein the body 310 has an interior that houses a motor 120 that is connected to a pump 125 and a battery power source 130. As with the embodiment shown in FIGS. 1 and 3, in an exemplary embodiment of an aquarium cleaning device having a gun-shaped body 310, the body 310 may define an opening 140 which, for example, permits for air (and/or water) to travel into the body 310 when it has been suctioned off of an aquarium surface by the device 300. The body 310 may also define a water inlet 170 which permits for water from the aquarium to be pulled into the body 310 and expelled through opening 140. A barrel 150 may be selectively received and maintained by the body 310 about the opening 140 such that the barrel may be utilized to direct water flowing out of the body 310 for cleaning objects and surfaces inside the aquarium and may also be utilized to remove water and undesirable materials from surfaces inside the aquarium. The barrel 150 may selectively receive one or more of a variety of accessories/attachments such as a curved nozzle 160 that permit for the device 310 to take different forms and to enable the cleaning of various areas and surfaces within the aquarium. As discussed above, a two-way pump 125 may permit for the same device 300 to be used to create a water flow out of opening 140 (wherein said water has come into the body 310 via the water inlet 170) as well as to pull air and/or soiled aquarium water into the body 310 (when the barrel is being used to suction water, debris, etc. off of surfaces inside the aquarium).

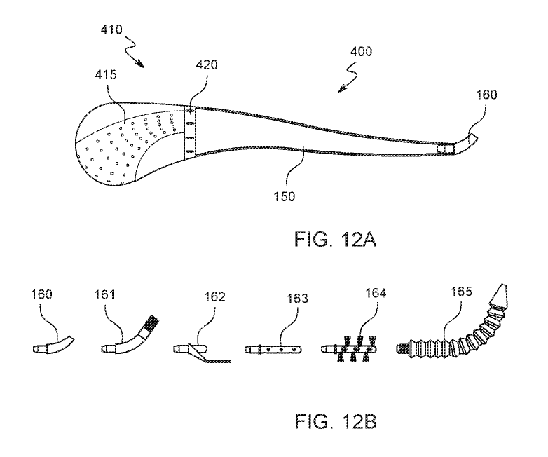

In some embodiments, such as that shown in FIG. 12(a), an aquarium cleaning device 400 may comprise a barrel 150 that selectively connects directly to a body 410 comprising a bulb 415 which creates a suction when a manual force is applied to the body 410 and then released. As shown in FIG. 12(a), the barrel 150 may connect to the body 410 via a threaded collar 420. In some embodiments, the same barrel 150 may be interchangeably attached to a body 110 and/or body 310 that comprises a motorized pump for different types of cleaning techniques. The barrel 150 that may be connected to body 410 may selectively receive one or more accessories. As is shown in FIG. 12(b), the accessories for the barrel 150 may be selected from the group consisting of a curved nozzle 160, a curved brush tip 161, a scraper 162, a tip defining one or more openings for water jets 163, a pipe cleaner tip 164, and a flexible pipe hose 165.

As shown in FIG. 12(b), a curved nozzle 160 accessory of an aquarium cleaning device may comprise a curved member having a first end and a second end wherein the member is hollow from one end to the other permitting for a flow of water through the member. Preferably, the first end of the member (or a polymeric material connected to and/or wrapped about the first end of the member) is adapted to fit into an opening defined by the second end of the barrel 150. There may be a pressure fit between the curved nozzle 160 and the barrel 150 such that the nozzle remains in place during cleaning of an aquarium, but may be removed by an application of sufficient manual force for cleaning of the device and/or changing to a different accessory. A curved brush tip 161 may also selectively received by barrel 150 for cleaning of an aquarium. Such as shown in FIG. 12(b), an example of the curved brush tip may be substantially the same in form as the curved nozzle 160, while further comprising a brush connected to its second end. Another accessory that may be received by a barrel 150 of an aquarium cleaning device is a scraper 162. Such as shown in FIG. 12(b), an example of a scraper 162 may comprise a member that may be received and selectively maintained by the second end of barrel 150. The member may or may not have an opening through it for the flow of water into and out of the barrel in different embodiments. A rigid arm protrudes from the member such that it may be utilized to scrape surfaces within an aquarium to dislodge debris. In embodiments wherein the member of the scraper 162 defines an opening that permits for water to flow out of the barrel 150 and into the aquarium, the rigid arm of the scraper may be positioned away from the opening so that it does not block the water flow. A tip defining one or more openings for water jets 163 may also be utilized by a device for cleaning an aquarium. Such as shown in FIG. 12(b), tip 163 may comprise a tubular member having a first end for receipt by a barrel 150 and a second end opposite the first end, wherein the second end of tip 163 may be closed or also have an opening for creating a water jet. Between the first end and the second end, the tip 163 defines at least one opening, and preferably a plurality of openings such that water jets are created when water is received by the body of the aquarium cleaning device and pumped out of opening 140 and into barrel 150, subsequently being expelled into the tip 163.

Other accessories are also possible. One other accessory that may be received by barrel 150 in some embodiments is a pipe cleaner tip 164. A pipe cleaner tip 164 may comprise a tubular member having a first end and a second end wherein the first end is received by a barrel 150. Between the first end and the second end of tip 164, a plurality of brushes is disposed. In an exemplary embodiment, the brushes may protrude from the tip 164 such that there are brushes going about the entire circumference of the tip 164. A flexible pipe hose 165 may also be connected to a barrel 150. Such as shown in FIG. 12(b), the flexible pipe hose may be a long, tubular member having a pointed tip. In an exemplary embodiment, the member of the hose 165 is preferably constructed from a polymeric material that permits for the hose to be flexed in a variety of directions upon application of manual force. The hose preferably has a first end and a second end and is hollow between the two ends to permit for a flow of water through the hose 165. The hose 165 may be received by the second end of the barrel 150. Such as shown in FIG. 15(b), a hose 165 may also be adapted to be received by a body 110 of a cleaning device 100 in lieu of and/or interchangeably with a barrel 150. In such embodiments, the hose 165 may be received by the body (e.g., 110, 410, 510, and/or 610) of the cleaning device 100 at the same point where the body 110 is adapted to receive a barrel 150 (Compare FIG. 15(a) with FIG. 15(b)). In some embodiments, a hose 165 may be received by the second end of the barrel 150 and may also be interchangeably received by/connected directly to the body (e.g., 110, 410, 510, and/or 610) of the device.

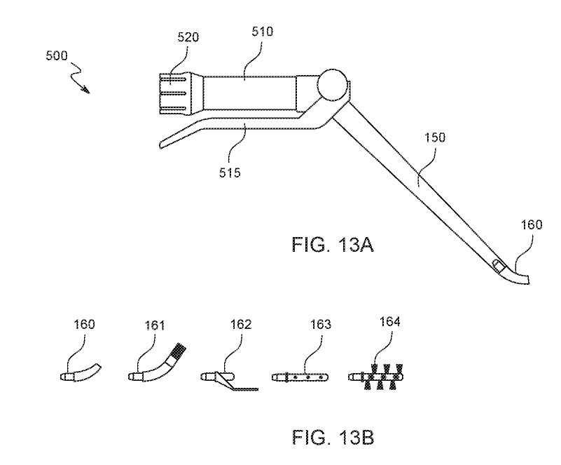

In some embodiments, such as that shown in FIG. 13(a), an aquarium cleaning device 500 may comprise a barrel 150 that selectively connects directly to a body 510 comprising a hand pump lever 515 in connectivity with a pump inside body 510 such that a force is created by the pump when a manual force is applied to the lever 515. Such as shown in FIG. 13(a), the barrel 150 may further comprise a pressure controller 520. Varying the amount of pressure applied to the pump within the body 510 may give the user control over the force of water or air into or out of the device 500, which may be regulated to the durability of the surface being cleaned. In some embodiments, the same barrel 150 may be interchangeably attached to a body 310 and/or body 110 that may comprise a motorized pump for different types of cleaning techniques. As with the embodiments previously discussed, the barrel 150 that may be connected to body 510 may selectively receive one or more accessories. As is shown in FIG. 13(b), the accessories for the barrel 150 may be selected from the group consisting of a curved nozzle 160, a curved brush tip 161, a scraper 162, a tip defining one or more openings for water jets 163, a pipe cleaner tip 164, and a flexible pipe hose 165 (not shown in FIG. 13(a)).

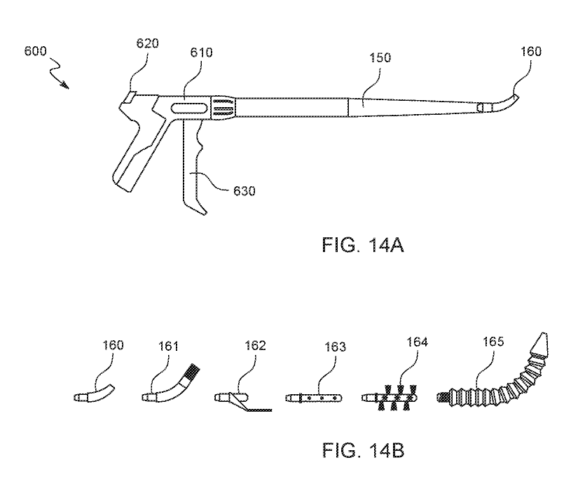

As shown in FIG. 14(a), some exemplary embodiments of an aquarium cleaning device 600 may comprise a gun-shaped body 610 that comprises an ergonomic pump lever 630 that may be triggered by application of manual force such that it creates a suction force within a barrel 150 that is selectively connected to the body 610. An example of the ergonomic pump lever 630 may be such that a relatively minimal amount of applied manual pressure causes a suction force needed to remove water and/or debris from an aquarium. Alternatively, an example of an ergonomic pump lever 630 may facilitate the discharge of water or air from the device for cleaning purposes. As shown, the body 610 may further comprise a pressure controller 620. As is shown in FIG. 14(b), the accessories for the barrel 150 may be selected from the group consisting of a curved nozzle 160, a curved brush tip 161, a scraper 162, a tip defining one or more openings for water jets 163, a pipe cleaner tip 164, and a flexible pipe hose 165.

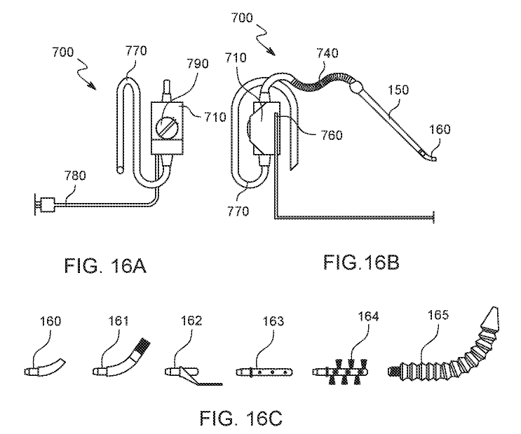

As shown in FIG. 16(a), some exemplary embodiments of an aquarium cleaning device 700 may comprise a body 710 having an interior that maintains a motor and pump, which are connected to an electric power source via a power cord 780. The motor and pump are not shown in FIG. 16(a) or 16(b) but upon reading this disclosure one of skill in the art will appreciate that there are a variety of motors and pumps which could be utilized by the device 700 to provide the desired functions. As shown, the body 710 may be connected to a water intake hose 770 that can be placed in an aquarium or other body of water to pull water into the body 710 which can then be expelled from the body via an extending flex hose 740 (FIG. 16(b)). The extending flex hose 740 may be adapted to receive and maintain a barrel 150 as shown so that water received by the body 710 via the intake hose 770 can be expelled through the flex hose 740 and barrel 150 for cleaning of an aquarium. The barrel 150 may be selectively received by the flex hose 740 in some embodiments so that the barrel 150, may be removed and exchanged with another barrel 150 or different cleaning accessory. As discussed above, the barrel 150 that is connectable to the flex hose 740 may selectively receive one or more of a variety of cleaning accessories such as a curved nozzle 160 to enable different cleaning functions. The aquarium cleaning device 700 may have a speed switch/invertor 790 which may not only serve as an on/off switch but which may also set the speed at which the water is pumped into the body 710. In embodiments comprising an inverter, it may be possible to change the direction of the pump such that water may be pulled from the aquarium into barrel 150 (if connected) and flex hose 740 for removal from the aquarium and alternatively water may be expelled into the aquarium through barrel 150 (if connected to hose 740) after the water has been received by the body 710 via the intake 770.

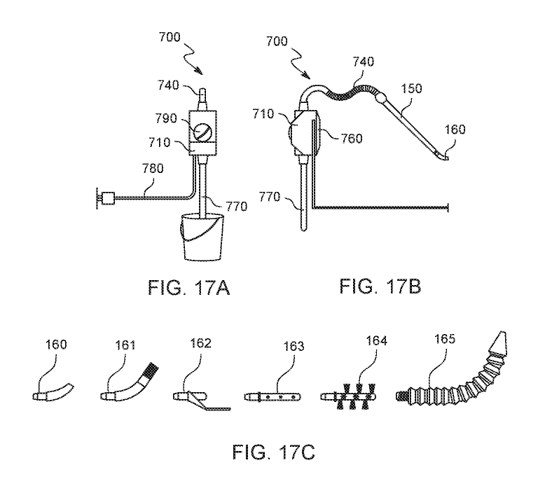

As shown in FIGS. 17(a) and 17(b), a water intake 770 may be positioned into a receptacle other than an aquarium, such as a bucket. In such embodiments, the bucket may be used to provide a fresh source of water to the aquarium or alternatively may be used to receive soiled water from the aquarium depending on which direction water is flowing through the body 710. An aquarium cleaning device 700 may additionally comprise a clamp 760 which permits for at least most of the body 710 of the device 700 (and thus its electric components) to be securely positioned outside of the aquarium during cleaning.

Some exemplary embodiments may comprise an aquarium cleaning kit. An example of an aquarium cleaning kit may include: 1) one or more bodies selected from the group consisting of body 110, body 310, body 410, body 510, body 610, and body 710; 2) at least one barrel 150; and one or more attachments selected from the group consisting of: a curved nozzle 160, a curved brush tip 161, a scraper 162, a tip defining one or more openings for water jets 163, a pipe cleaner tip 164, and a flexible pipe hose 165. In one embodiment, an exemplary aquarium cleaning device kit may comprise a first body comprising a pump, motor, and power source (such as a battery) as well as a second body comprising a manually operated pump; a barrel having a first end and second end that may be interchangeably connected to the first body and the second body at the first end of the barrel; and one or more cleaning accessories that may be selectively received by the second end of the barrel.

In one exemplary embodiment of an aquarium cleaning device 100, a filter may be disposed within the body 110, wherein the filter helps ensure that substantially only water may be pulled into the pump 125. In other exemplary embodiments, the pump 125 may be utilized to draw water (as well as certain debris and unwanted material) from the aquarium and into a filter to be removed from the aquarium.

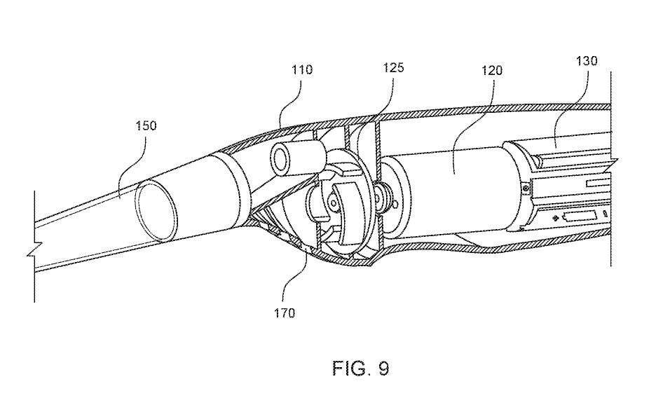

In exemplary embodiments, the barrel 150 may be made from polymeric material which may also provide flexibility to the device 100. For example, the barrel 150 may be made from flexible silicone tubing. Other polymeric materials that may be utilized include, for example, flexible PFA, nylon, vinyl, PVC, polyurethane, polyethylene, or other suitable materials. In another exemplary embodiment, the barrel 150 may comprise a metal matrix that is covered by a polymeric material, wherein the metal matrix provides the desired flexibility and rigidity, and the polymeric covering enables for the formation of a cavity within the barrel 150 that is needed to enable a directed water flow. For example, a polyurethane hose that has been reinforced with a bronze coated spring steel wire helix (such as is shown in FIG. 9) may be utilized for the barrel 150 in some exemplary embodiments. In some exemplary embodiments, the barrel 150 may be made from a flexible metal such as a stainless steel flexible tubing. Metallic materials utilized for the barrel 150 may also include, for example, galvanized metals, flexible aluminum, flexible copper, etc. When metal is utilized, the metal material of the device 100 may be treated to prevent rusting from exposure to water. In some exemplary embodiments, the device 100 may be manufactured from a combination of plastic, rubber, and rubber coated metal for increased durability and water safety. In some embodiments, the barrel 150 is not flexible/pliable, but different shapes and functions of the device 100 may be obtained by attaching one or more of a variety of cleaning accessories to the second end of the barrel 150.

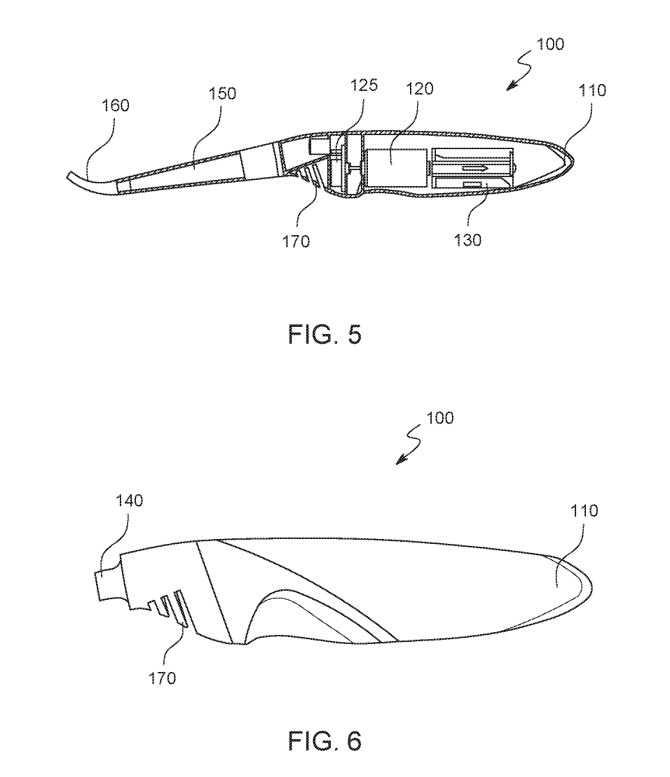

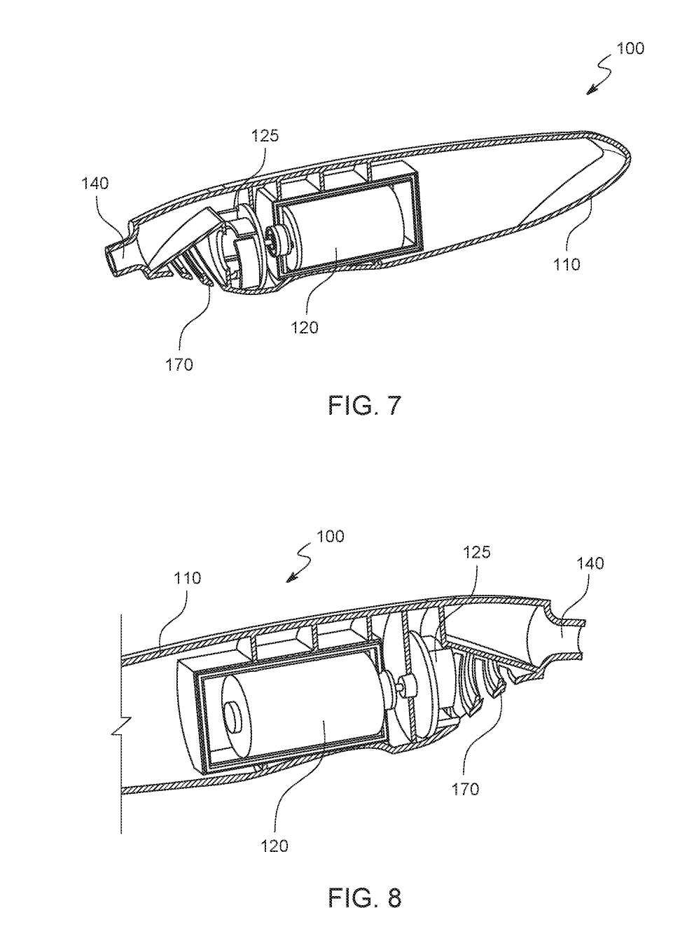

The pump utilized by an aquarium cleaning device may be manually powered/operated in some exemplary embodiments, while in other embodiments the pump may be motorized and powered by electricity, mechanical power, or some other power source. FIGS. 1, 2, 3, 5, 7, 8, 9, 10, and 11 show exemplary embodiments of a motorized water pump that may be placed inside a body (e.g., 110, 310, and 710) in some embodiments of an aquarium cleaning device. One exemplary embodiment of an aquarium cleaning device 100 comprises a wireless motorized pump 125. In some exemplary embodiments, the wireless motorized pump 125 is battery operated. An exemplary embodiment of the pump 125 may be completely and safely submersible in water or other fluid so that there are minimum risks posed to users during use of the device 100. In some embodiments, the pump 125 may be connected to a water removal body, such as tube 770 in the FIG. 16 embodiment, that may be utilized to carry water, debris, or other unwanted material from the aquarium to a desired location (such as a sink, bucket, etc.) for disposal or treatment. A motorized pump 125 may be helpful by relieving users from having to squeeze/apply force to a manual pump. Specifically, the pump's motor 120 may generate force which may cause water, debris, or other unwanted material to be pulled in through the body 110 of the device so that it may be removed from the aquarium and/or cause water or air to be pushed out of the body 110 and into the aquarium in order to dislodge particles, debris, etc. from aquarium surfaces. In some exemplary embodiments, the motorized pump 125 may comprise a means for setting the flow rate of water that is directed into and/or that is removed from the aquarium. For example, and as is shown in FIGS. 16 and 17, the pump may include a knob that permits users to select between various flow rates (e.g., low, medium, high, etc.) and/or flow directions.

In some exemplary embodiments, an aquarium cleaning device 100 may comprise a barrel 150 having a form/shape only part of which may be selectively manipulated by application of force by a user. In one such exemplary embodiment, the barrel 150 has a first end and a second end, wherein the first end has a form that may be selectively manipulated. In such an embodiment, the second end is not capable of such manipulation and may, for example, be connected to the body 110 of the device 100. Such an embodiment may allow for a more rigid material to be used in fabricating at least portion of the barrel 150 (e.g., the second end), which may enable a longer useful life as well as help strike the balance between the strength of the pump 125 that may be utilized/needed and the rigidity of the barrel 150, while still providing the flexibility desired to enable cleaning of otherwise difficult to reach areas within the tank/aquarium.

Any embodiment of the disclosed system and method may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention.

What is claimed is:

1. An aquarium cleaning device comprising:
A body adapted to be held by a human hand wherein said body comprises:
an interior housing a pump; and
a first end defining an opening such that application of force in a first direction to the pump causes air to be expelled from the interior of the body through the opening of the body;
a barrel member that is tubular in shape having an open first end and an open second end wherein the barrel is hollow from the first end to the second end and the first end of the barrel is adapted to be selectively received by the first end of the body at the opening defined by the body; and
one or more cleaning accessories adapted to be selectively received by the second end of the barrel.

2. The device of claim 1 wherein the barrel member is rigid and curved.

3. The device of claim 1 wherein the one or more cleaning accessories is selected from the group consisting of a curved nozzle, a curved brush tip, a scraper, a tip defining one or more openings for water jets, a pipe cleaner tip, and a flexible pipe hose.

4. The device of claim 1 wherein the body further comprises a motor in electrical connectivity with the pump.

5. The device of claim 4 wherein the body further comprises one or more batteries in connection with the motor.

6. The device of claim 1 wherein the body further comprises a lever connected to the pump such that application of manual pump to the level applies force to the pump.

7. The device of claim 1 wherein the body further defines an inlet and a passage for a flow of fluid from the inlet to the opening defined by the first end of the body.

8. The device of claim 7 wherein the motor is further capable of receiving force in a second direction causing fluid to flow into the opening defined by the first end of the body and expelled from the inlet.

9. The device of claim 8 wherein the fluid is selected from the group consisting of water and air.

10. A device for cleaning an aquarium comprising:
a body connected to a pump wherein the body has a first end defining an opening for receiving a flow of fluid;
a hollow barrel having a first end and a second end wherein the first end of the barrel is adapted to be selectively connected to the body such that fluid may flow through the barrel and into the opening defined by the first end of the body upon an application of force in a first direction to the pump; and
one or more cleaning accessories selectively received by the second end of the barrel.

11. The device of claim 10 wherein the one or more cleaning accessories comprises a flexible pipe hose that may be connected to the first end of the body instead of the barrel.

12. The device of claim 10 wherein the pump comprises a bulb that is operated by application of manual force.

13. The device of claim 10 wherein the body further comprises a motor in connectivity with the pump.

14. The device of claim 10 wherein the barrel is selectively connected to the body by a hollow tube that permits for fluid to flow from the barrel to the opening defined by the first end of the body.

15. The device of claim 10 wherein the body further comprises:
a motor in connectivity with the pump;
an intake hose connected to the body and that permits for fluid to flow into the body; and
a path within the interior of the body connecting the intake hose to the opening defined by the first end of the body;
wherein the pump is capable of receiving force in a first direction and a second direction such that varying the direction of the force applied to the pump changes the direction of the fluid flow through the body between the intake hose and the opening defined by the first end of the body.

16. The device of claim 15 wherein the pump and motor are housed in the interior of the body and the body further comprises a power cord in connectivity with the motor and the barrel is selectively connected to the body by a hollow tube that permits for fluid to flow from the barrel to the opening defined by the first end of the body.

17. An aquarium cleaning kit comprising:
a first body comprising:
a manually operated pump;
a first end that defines an opening into the interior of the first body; and
a pathway connecting the opening defined by the first end of the body to the pump;
a second body comprising:
an interior housing a pump in connectivity with a motor;
a first end that defines an opening into the interior of the second body; and
a pathway connecting the opening defined by the first end of the second body to the pump;
at least one barrel that is tubular in shape having an open first end and an open second end wherein the first end of the barrel is adapted to be received by the first end of the first body and the first end of the second body; and
at least one cleaning accessory adapted to be received by the second end of the barrel.

18. The cleaning kit of claim 17 wherein the at least one cleaning accessory is selected from the group consisting of: a curved nozzle, a curved brush tip, a scraper, a tip defining one or more openings for water jets, a pipe cleaner tip, and a flexible pipe hose.

19. The cleaning kit of claim 17 wherein the barrel is rigid and curved.

20. The cleaning kit of claim 18 wherein the second body further defines a water inlet and the pathway of the second body extends from the inlet to opening defined by the first end of the second body.
